(19) United States
(12) Patent Application Publication
(10) Pub. No.: US 2002/0053610 A1
(43) Pub. Date: May 9, 2002

(54) FUEL INJECTORS

(76) Inventors: TAKAAKI TAKAGI, OBU-SHI (JP); KENZO NAGASAKA, OBU-SHI (JP)

Correspondence Address: SCOTT T WAKEMAN, DENNISON MESEROLE SCHEINER & SCHULTZ, 1745 JEFFERSON DAVIS HIGHWAY SUITE 612, ARLINGTON, VA, 22202

(21) Appl. No.: 09/429,896

(22) Filed: Oct. 29, 1999

(30) Foreign Application Priority Data
Nov. 10, 1998 (JP) 10-319456

(51) Int. Cl. F02M 61/00

(52) U.S. Cl. 239/533.2; 239/584

(57) ABSTRACT

A jet opening 13a for injecting fuel can be opened and closed by a ball valve 23 of a movable element 20. An orifice plate 14 is disposed on a downstream side of the jet opening and has between about eight to eighteen circular jet holes formed for further atomizing fuel particles exhausted by the jet opening 13a. Upstream side openings of the jet holes can be dispersed on a plurality of circles. A thickness t of the orifice plate and a diameter φd of the jet holes can be set to be 0.53≦t/φd≦0.82. A shortest distance L between said upstream side openings of the jet holes and a diameter φd of the jet holes can be set to be L>φd.

### BACKGROUND OF THE INVENTION

1. Field of the Invention

The present invention relates to fuel injectors, and more particularly, to fuel injectors for injecting fuel into vehicle engines.

2. Description of the Related Art

An example of a known fuel injector for injecting fuel into a vehicular engine is disclosed in Japanese Laid-Open Patent Publications Nos. 8-200188, 8-218973, and 9-14090 and is reproduced in FIG. 19, which shows a sectional view of a fuel jet section of the fuel injector. This fuel injector primarily includes an injector body 100 having a generally cylindrical body 101, a circular jet opening 113a, a valve seat 113 and a movable element 120. The valve seat 113 is disposed within the body 101. The movable element 120 is provided within the valve seat 113, is axially movable with respect to the body 101 and also includes a ball valve 123. Axial movement of the movable element 120 causes the ball valve 123 to open and close the jet opening 113a, thereby intermittently exhausting fuel from the jet opening 113a. The fuel exhausted from the jet opening 113a is separated (or atomized) into particles as a result of passing through the ball valve 123 and the jet opening 113a.

A stainless orifice plate 114 is mounted on the downstream side of the jet opening 113a of the valve seat 113 and is attached to the tip surface of the valve seat 113 by laser welding (at welds 112). The orifice plate 114 also has an outer peripheral portion including a forwardly bent annular mounting portion 114b, which mounting portion 114b is laser welded to the inner peripheral surface of the body 101 (at welds 115).

The orifice plate 114 has circular jet holes 114a for further atomizing the fuel particles that are exhausted from the jet opening 113a. That is, passing the fuel particles through the circular jet holes 114a reduces the size of the fuel particles exhausted by the jet opening 113a. For the purposes of this discussion, the fuel exhausted by the jet opening 113a will be referred to as “fuel particles” and the fuel exhausted by the jet holes 114a will be referred to as “atomized fuel,” in which the term “atomized fuel” is intended to mean fuel particles that are smaller than “fuel particles.”

It is known that the combustion efficiency of an engine can be improved by further atomizing the fuel particles that are exhausted from the jet openings of a fuel injector. Therefore, in the known fuel injector, one to four jet holes 114a are provided in the orifice plate 114 and the diameter of each jet hole 114a is determined by calculations based on the required fuel flow. The jet holes 114a are inclined with respect to the central axis of the orifice plate 114 such that the jet holes 114a are directed downward and away from the central axis of the orifice plate. The portion of the movable element 120 that faces the orifice plate 114 has a flat surface.

### SUMMARY OF THE INVENTION

As a result of research that was conducted in order to provide an improved atomized fuel source, it was determined that the number and arrangement of the jet holes in the orifice plate and the ratio between the thickness of the orifice plate and the diameter of the jet holes can affect the particle size of the atomized fuel. For example, the fuel particles that are exhausted from the injector jet opening can be further atomized by appropriately choosing the number and arrangement of the jet holes in the orifice plate. In addition or in the alternative, the ratio between the thickness of the orifice plate and the diameter of the jet holes can be adjusted to improve fuel atomization.

It is, accordingly, an object of the present teachings to provide fuel injectors that improve fuel atomization.

In one aspect of the present teachings, the thickness t of the orifice plate and the diameter φd of the jet holes are chosen to satisfy a ratio of about 0.53 ≦t/φd≦0.82. In this case, a flat surface having a diameter φD also may preferably be formed in a portion of the movable element that faces the orifice plate. Upstream side openings of the jet holes may be located within a circle of diameter φD in the orifice plate on the side of the orifice plate that faces the flat surface of the movable element.

The jet holes may be formed along respective inclined axes that are inclined with respect to the central axis of the orifice plate, such that the jet holes are directed downward and away from the central axis of the orifice plate. As a result, turbulent flow can be produced within the jet holes, while avoiding a decrease in the velocity of the fuel that is exhausted from the jet holes, thereby further atomizing the exhausted fuel particles. Alternatively, the jet holes may be formed along the respective axes that extend onto a head portion of an intake valve. In this case, excessive spreading of the fuel particles exhausted from the jet holes can be prevented, which spreading may otherwise be caused by interference with the intake valve shaft.

In another aspect of the present teachings, the jet holes may be arranged on a plurality of circles around a center point of the orifice plate. In this case, the shortest distance L between the upstream side openings of the jet holes and the diameter φd of the jet holes may be chosen such that L>φd. With such an arrangement, fuel flows in a smooth stream to the jet holes, so that further atomization of the fuel particles can be achieved. Further, by dispersing the openings of the jet holes on a plurality of circles, a greater number of the jet holes can be efficiently positioned within a limited space.

In further aspect of the present teachings, the openings of the jet holes may be located within a circle of the diameter φD in the orifice plate that intermittently contacts the flat surface of the movable element. The jet holes may be formed along the respective inclined axes that are inclined with respect to the central axis of the orifice plate such that the jet holes are directed downward and away from the central axis of the orifice plate and do not interfere with each other. With such an arrangement, the atomized fuel exhausted from the jet holes can be prevented from interfering with each other and hence from coalescing into larger particles.

Additional objects, features and advantages of the present invention will be readily understood after reading the following detailed description together with the accompanying drawings and the claims.

### BRIEF DESCRIPTION OF THE DRAWINGS

FIG. 1 is a sectional view of a first representative embodiment of an improved fuel injector;

FIG. 2 is a sectional view of a fuel jet section of the first representative embodiment;

FIG. 3 is a rear view of an outside magnetic path forming member of the first representative embodiment;

FIG. 4 is a plan view of the outside magnetic path forming member of the first representative embodiment;

FIG. 5 is a sectional view taken along line V-V in FIG. 3;

FIG. 6 is a side view of a movable element of the first representative embodiment;

FIG. 7 is a sectional view taken along line VII-VII in FIG. 6;

FIG. 8 is a sectional view taken along line VIII-VIII in FIG. 7;

FIG. 9 is a perspective view of a valve seat assembly;

FIG. 10 is a partial end view of an orifice plate of the first representative embodiment, as seen from the upstream side thereof;

FIG. 11 is a sectional view taken along line XI-XI in FIG. 10;

FIG. 12 is a partial end view of the orifice plate of the first representative embodiment, as seen from the upstream side thereof;

FIG. 13 is a sectional view of the front end of the movable element and the parts proximal to the movable element of the first representative embodiment;

FIG. 14 is a characteristic graph showing the relationship between the ratio (t/φd) of the thickness t of the orifice plate to the diameter φd of the jet holes and the particle size of the atomized fuel;

FIG. 15 is a characteristic graph showing the relationship between the number of the jet holes and the particle size of the atomized fuel;

FIG. 16 is an explanatory view showing a target point for injected fuel in a second representative embodiment;

FIG. 17 is a partial end view of the orifice plate of the second representative embodiment, as seen from the downstream side;

FIG. 18 is a partial end view of the orifice plate of a third representative embodiment, as seen from the upstream side; and

FIG. 19 is a sectional view of a fuel jet section of a known injector.

### DETAILED DESCRIPTION OF THE INVENTION

A fuel injector may include a body having a fuel jet opening, a movable element that intermittently contacts the jet opening to open and close the jet opening, and an orifice plate disposed on the downstream side of said jet opening. In one preferred embodiment, between about 8 to 18 jet holes are formed in the orifice plate. The thickness t of the orifice plate and the diameter φd of the jet holes may preferably be selected to satisfy a ratio of about 0.53≦t/φd≦0.82.

The movable element may have a flat surface of a diameter φD formed in a portion of the movable element that intermittently contacts the orifice plate. In such an embodiment, the jet holes may be disposed within a circle of the diameter φD in the orifice plate that intermittently contacts said flat surface. The jet holes also may be formed along respective inclined axes that are inclined with respect to the central axis of the orifice plate such that the jet holes are directed downward and away from the central axis of the orifice plate. Further, the inclined axes of the jet holes may be defined so as not to interfere with each other. The jet holes also may be formed along respective axes that extend onto a head portion of an intake valve.

Upstream side openings of the jet holes may be arranged or dispersed on a plurality of circles. Moreover, the shortest distance L between said upstream side openings of the jet holes may be less than the diameter φd of the jet holes.

In addition or in the alternative, the fuel injector may include a body having a fuel jet opening, a movable element that intermittently contacts said jet opening to open and close the jet opening, and an orifice plate disposed on the downstream side of said jet opening, which orifice plate has a plurality of jet holes formed therein. The movable element may have a flat surface of a diameter φD formed in a portion of the movable element that intermittently contacts said orifice plate. The jet holes may be disposed within a circle of the diameter φD in the orifice plate that intermittently contacts said flat surface and may be formed along respective inclined axes that are inclined with respect to the central axis of the orifice plate such that the jet holes are directed downward and away from the central axis of the orifice plate. Further, the inclined axes of the jet holes may be defined so as not to interfere with each other.

The fuel jet opening and movable element may be any type of structure appropriate for a fuel injector and the design shown herein is not meant to be limiting as to the types of structures that can perform the operation of exhausting fuel from the injector body. The fuel jet opening and the movable element of the present invention are merely intended to provide a means for dispensing fuel and for atomizing the fuel. Any type of structure that can perform this function is appropriate for use with the present teachings. The orifice plate of the present teachings then further atomizes the fuel particles. Various designs for the orifice plate can be utilized either separately or together, depending upon the designer's desires.

Thus, each of the additional features and method steps disclosed above and below may be utilized separately or in conjunction with other features and method steps to provide improved fuel injectors and methods for designing and using such fuel injectors. Representative examples of the present invention, which examples utilize many of these additional features and method steps in conjunction, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe some representative examples of the invention.

(First Embodiment)

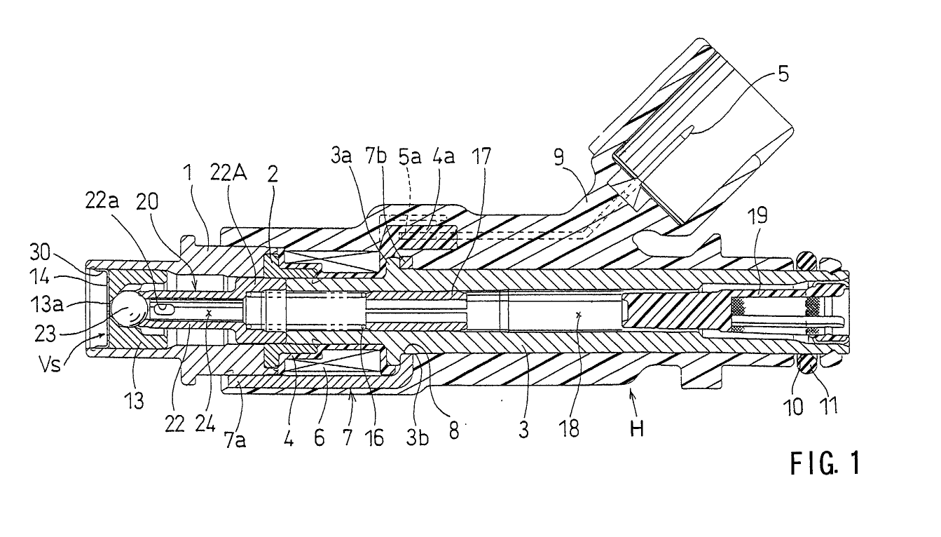

A first representative embodiment will now be described with reference to FIGS. 1 to 14. FIG. 1 is a sectional view of the fuel injector, in which fuel flows from the right to the left in the drawing. In the following description, the right side of FIG. 1 will be referred to as the “forward” or “upstream side,” and the left side will be referred to as the “rearward” or “downstream side.”

Generally speaking, the fuel injector of FIG. 1 may include an injector body H including a body 1, a valve seat 13 and a movable element 20. The valve seat 13 may have a jet opening 13a and the valve seat is preferably inserted within the body 1. The jet opening 13a of the valve seat 13 can be opened and closed by a ball valve 23 mounted on the movable element 20 that is axially movable within the valve seat 13. An orifice plate 14 is preferably disposed on the downstream side of the valve seat 13. The orifice plate 14 may have jet holes 14a for further atomizing fuel particles that are exhausted from the jet opening 13a. In this embodiment, the injector body H with the orifice plate 14 is called a fuel injector.

The construction of a fuel injector of the first representative embodiment will now be explained in greater detail. The body 1 preferably includes a ferromagnetic material and has a generally cylindrical shape. A ring 2 preferably includes a non-ferromagnetic material and has a generally short cylindrical shape. A forward portion of the ring 2 may be press fitted into the rear end portion of the body 1 and can be welded to the body 1. A forward end of a hollow shaft-like core 3 also may include a ferromagnetic material, may be press fitted into the rear end portion of the ring 2 and can be welded to the ring 2. The core 3 may have a radially outwardly protruding flange 3a formed generally in the middle portion thereof in its axial direction. The core 3 further may have a raised portion 3b that is located at the rear of the flange 3a. The outer diameter of the core 3 at the raised portion 3b can be slightly larger than that at the portion rearward of the raised portion 3b.

A bobbin 4 of an electrically insulating material, such as synthetic resin, may be disposed around a connection between the ring 2 and the core 3. A solenoid coil 6 can then be wound around the bobbin 4. The bobbin 4 may have a terminal mounting portion 4a formed on the rear end of the bobbin 4 and a connecting end 5a of a terminal 5 may be press fitted into the terminal mounting portion 4a. Preferably, the connecting end 5a of the terminal 5 is electrically connected to the solenoid coil 6.

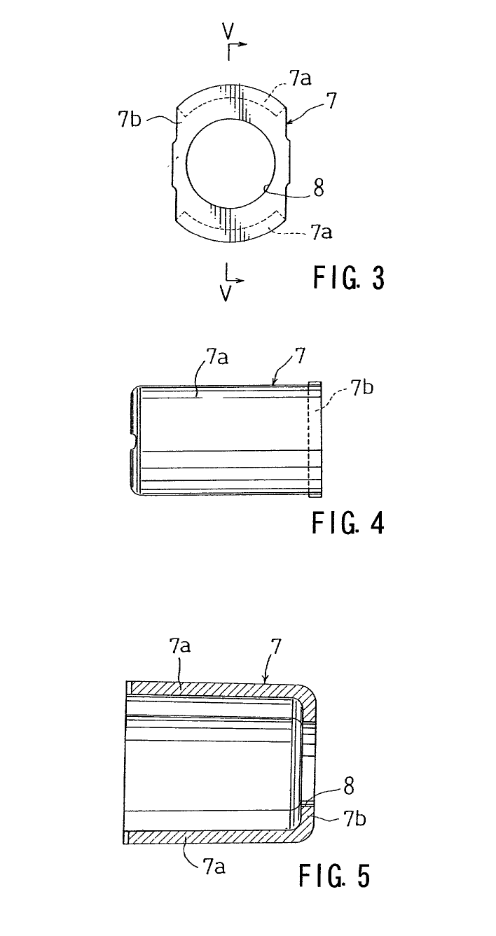

The outer peripheral portion of the solenoid coil 6 can be partially surrounded by an outside magnetic path forming member 7 and FIG. 3 shows a rear view of a representative outside magnetic path forming member 7. FIG. 4 is a plan view of the representative outside magnetic path forming member and FIG. 5 is a sectional view taken along line V-V in FIG. 3. The outside magnetic path forming member 7 may have a generally elliptical (oval) cross-section and may include an end plate 7b and a pair of extension pieces 7a. The end plate 7b may have a circular mounting hole 8 located in the center. The pair of extension pieces 7a may extend forward from the upper and lower edges of the end plate 7b, respectively, and can have an arcuate cross-section. The diameter of the mounting hole 8 is preferably slightly smaller than the outer diameter of the raised portion 3b of the core 3. The outside magnetic path forming member 7 can be formed, for example, by deep drawing a single piece of ferromagnetic metal plate. The mounting hole 8 can be formed, for example, by stamping.

The rear end of the core 3 can be inserted into the mounting hole 8, and the raised portion 3b of the core 3 may be press fitted into the mounting hole 8 until the end plate 7b contacts the flange 3a of the core 3 from the axial direction. As a result, the outside magnetic path forming member 7 is positioned and mounted on the core 3. Further, the forward ends of the extension pieces 7a of the outside magnetic path forming member 7 may be coupled to the rear end of the body 1, for example, by welding.

As shown in FIG. 1, a resin molding may surround a peripheral portion extending from the rear half portion of the body 1 to the rear end of the core 3 and a connector 9 may be formed around the terminal 5 by the resin molding. The connector 9 is preferably connected to a power supply connector of an electronic control unit (not shown). The electronic control unit thus controls the power supply to the solenoid coil 6.

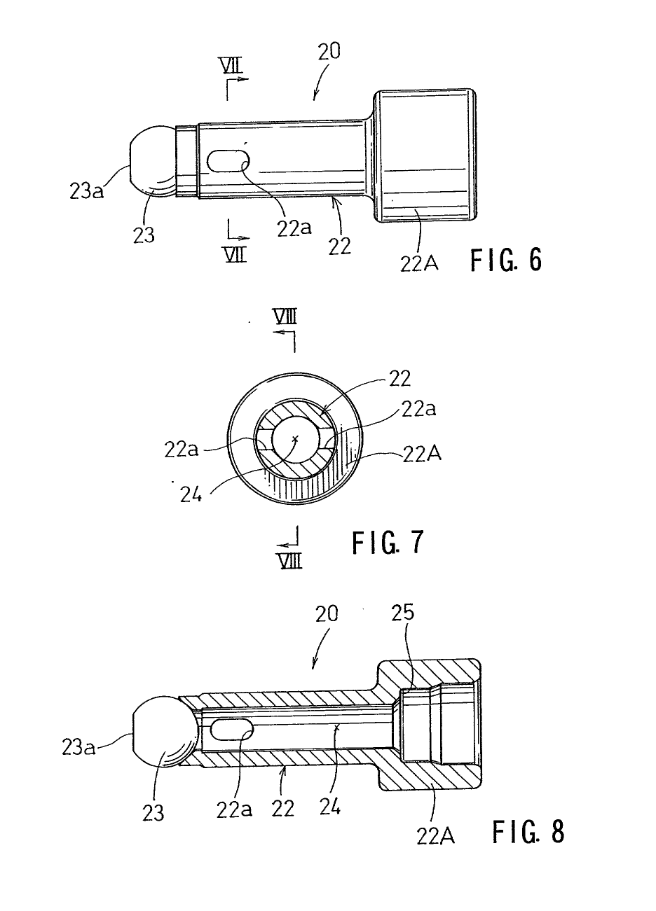

A representative movable element 20, which will now be explained in greater detail, is axially slidably inserted in the connection of the body 1 with the ring 2. FIG. 6 is a side view of such a movable element 20, FIG. 7 is a sectional view taken along line VII-VII in FIG. 6, and FIG. 8 is a sectional view taken along line VIII-VIII in FIG. 7. The movable element 20 may, for example, include an armature 22 and a ball valve 23. The armature 22 may include a ferromagnetic material and have a hollow shaft-like shape. The ball valve 23 can be attached to the armature 22 to close a front end opening of the armature 22. A pair of holes 22a may be formed in the side wall of the armature 22 adjacent to the front end of the armature 22. The hollow portion of the armature 22 and the holes 22a preferably define a fuel passage 24 (FIG. 8) in the armature 22. The armature 22 may have an integrally formed larger-diameter cylindrical portion 22A at the rear end of the cylindrical portion 22A. Further, as shown in FIG. 8, the armature 22 may have a stepped surface 25 formed within the inner peripheral surface thereof at the junction of the larger-diameter cylindrical portion 22A and a forward smaller-diameter cylindrical portion (unnumbered).

The armature 22 is preferably one piece and can be formed, for example, by metal injection molding. Metal injection molding is well known and typically includes the steps of kneading, molding, liquid degreasing and sintering. The kneading step usually includes kneading fine metal powder with a binder. The molding step usually includes molding the kneaded material with an injection molding machine. The liquid degreasing step usually includes removing the binder from the molded product using a solvent in a degreasing furnace. Finally, the sintering step usually includes sintering the degreased molded product in a sintering furnace. A ferromagnetic material, such as electromagnetic SUS or permalloy, may be used as the metal material.

The movable element 20 may be inserted in the body 1 as shown in FIG. 1. Specifically, the enlarged diameter portion 22A of the armature 22 can be slidably inserted into the body 1 and the ring 2. The armature 22 is attracted to the core 3 by a magnetic force generated when power is supplied to the solenoid coil 6.

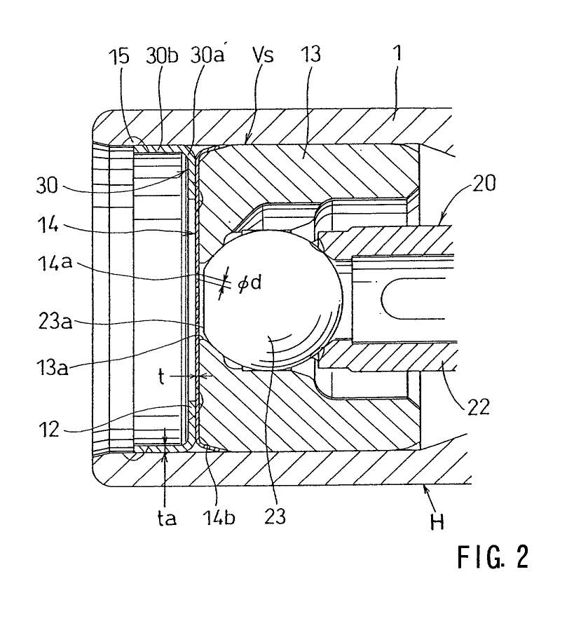

A valve seat assembly Vs may be inserted into the front end portion of the body 1. A cross section of a representative fuel jet section, including the valve seat assembly Vs, is partially shown in FIG. 2. The valve seat assembly Vs may include the valve seat 13, the orifice plate 14 and a plate holder 30. The valve seat 13 preferably has a generally cylindrical shape with a bottom and has at least two jet openings 13a formed in the front end surface of the valve seat 13. Fuel is exhausted from the injector body 1 through the valve seat assembly Vs.

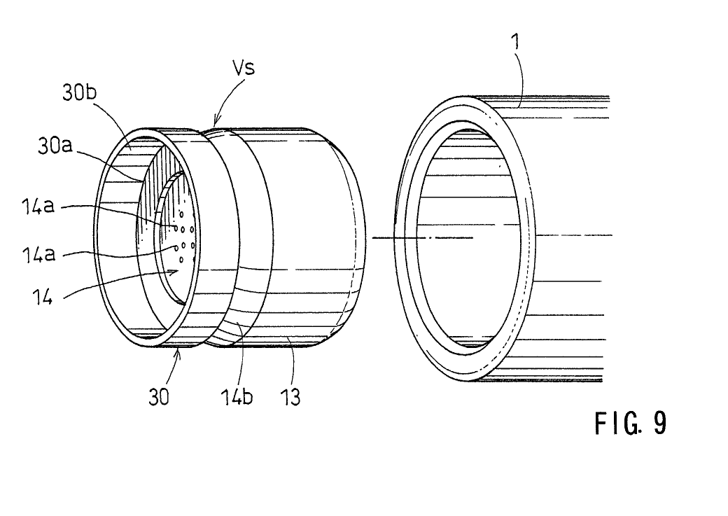

The orifice plate 14 preferably includes a stainless circular plate and can be disposed on the front end surface of the valve seat 13 (on its downstream side). The orifice plate 14 preferably has circular jet holes 14a formed in the central portion of the orifice plate 14 and in communication with the jet opening 13a of the valve seat 13 in order to atomize fuel exhausted from the jet opening 13a. The jet holes 14a will be described below in further detail. The perimeter of the orifice plate 14 is preferably bent rearward, thereby defining an annular fitting portion 14b, which fitting portion 14b is fitted on the front end of the valve seat 13. The representative valve seat assembly Vs is shown in FIG. 9 in perspective view before being assembled into the body 1.

Further, as shown in FIG. 2, the plate holder 30 may include a stainless annular plate and preferably is disposed on the perimeter of the front end surface of the orifice plate 14. The perimeter of the plate holder 30 is preferably bent forward through a bent portion 30a having an L-shaped section, thereby defining an annular mounting portion 30b. The inner perimeter of the plate holder 30 can be laser welded to the valve seat 13 (at welds 12) through the orifice plate 14, which is preferably disposed between the plate holder 30 and the valve seat 13.

After construction, the valve seat assembly Vs may be inserted into the front end portion of the body 1. The mounting portion 30b of the plate holder 30 can be laser welded to the inner peripheral surface of the body 1 (at welds 15). The jet opening 13a of the valve seat 13 may be opened and closed by the ball valve 23 of the movable element 20.

Positional adjustment of the valve seat 13 with respect to the body 1 can be effected by plastically deforming the bent portion 30a of the plate holder 30. Specifically, upon forcing the valve seat 13 rearward into the body 1, the bent portion 30a of the plate holder 30 can be plastically deformed to enlarge the bend angle of the bent portion 30a. After removing the force on the valve seat 13, the valve seat 13 is fixed in position.

The thickness ta of the plate holder 30 can be chosen to ensure sufficient rigidity, such that the bent portion 30a is not deformed by the fuel pressure that will be applied to the valve seat 13 during operation of the fuel injector. The thickness t of the orifice plate 14 can be chosen to ensure that the jet holes 14a have sufficient length to provide direction to the fuel particles that pass through the jet holes 14a.

A valve spring 16 may be inserted into the core 3 and then a spring pin 17 having a C-shaped cross-section can be press fitted into the core 3. The front end of the valve spring 16 may be inserted into the larger-diameter portion 22A of the armature 22 of the movable element 20 and may be supported by the stepped surface 25 (see FIG. 8) of the armature 22. The valve spring 16 preferably urges the movable element 20 in the direction to close the valve (forwardly) against the spring pin 17.

The inner space extending from the rear end opening of the core 3 to the jet opening 13a of the valve seat 13 preferably includes a fuel passage 18. A strainer 19 may be press fitted into the rear end portion of the core 3. When the connector 9 is formed by a resin molding technique, an annular groove 10 can be formed around the outer periphery of the rear end portion of the core 3. An O-ring 11 may be fitted in the annular groove 10, which O-ring 11 serves to provide a seal between the core 3 and a delivery pipe (not shown) connected to the core 3.

Preferred materials for forming the main component parts of the fuel injector are: electromagnetic SUS for the body 1, SUS304 for the ring 2, electromagnetic SUS for the core 3, electromagnetic SUS for the outside magnetic path forming member 7, electromagnetic SUS or permalloy for the armature 22, SUS440C for the valve seat 13 and SUS304 for the orifice plate 14 and the plate holder 30. Naturally, other materials may be utilized to make the present injectors.

One representative mode for operating the present fuel injectors will be explained next. Fuel of a predetermined pressure is supplied from a fuel tank (not shown) and may be filtered by passing it through the strainer 19. The fuel is then directed into the inside of the valve seat 13 through the fuel passage 18. When power is not supplied to the solenoid coil 6, the movable element 20 is urged or biased forwardly by the valve spring 16 to close the valve, so that the jet opening 13a of the valve seat 13 is closed. Therefore, the fuel is not exhausted from the jet opening 13a.

When power is supplied to the solenoid coil 6, a magnetic path is formed running through the core 3, the armature 22 of the movable element 20, the body 1 and the outside magnetic path forming member 7. Therefore, a magnetic force is generated between the core 3 and the armature 22, thereby causing the movable element 20 to move rearwardly to open the valve. As a result, the ball valve 23 of the movable element 20 separates from the valve seat to open the jet opening 13a and fuel particles are exhausted from the jet opening 13a, which fuel particles are further atomized by passing the fuel particles through the jet holes 14a (see FIG. 2) of the orifice plate 14.

Then, when power to the solenoid 6 is stopped, the magnetic attraction between the core 3 and the armature 22 is terminated. As a result, the movable element 20 is displaced by the spring force of the valve spring 16 in the direction of closing the valve. Therefore, the jet opening 13a is again held closed by the ball valve 23 of the movable element 20 and the fuel injection from the jet opening 13a is stopped.

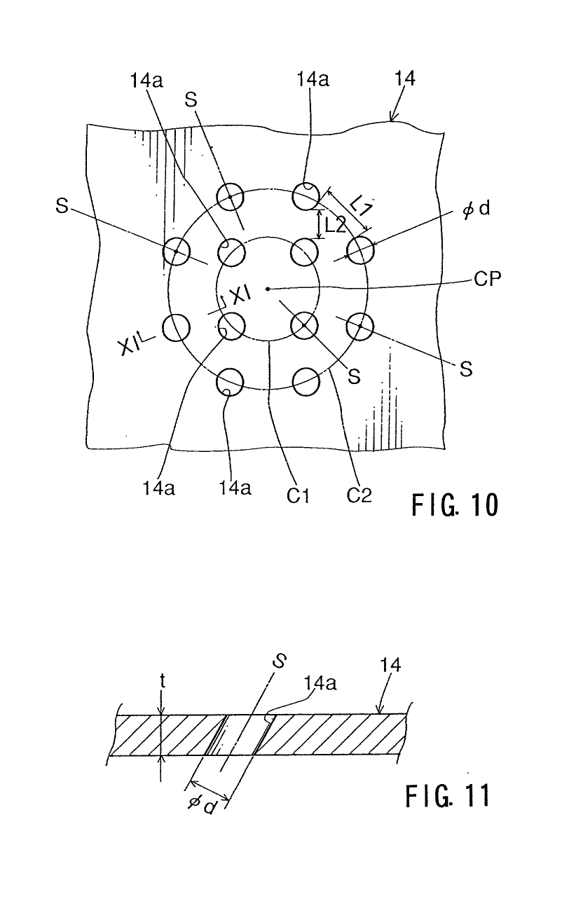

Representative jet holes 14a will now be described with respect to preferred diameter and positional arrangements. FIG. 10 is a partial end view of the orifice plate 14, as seen from the upstream side thereof. FIG. 11 is a sectional view taken along line XI-XI in FIG. 10. As shown in FIG. 11, each of the jet holes 14a comprises a circular hole having an oblique axis S such that the opening of the downstream side (lower side in FIG. 11) is located at a longer distance away from the central axis of the orifice plate 14 than the opening to the upstream side (upper side in FIG. 11). The jet holes 14a may be formed by press molding the orifice plate 14.

As shown in FIG. 10, the jet holes 14a of this particular representative embodiment are formed such that the upstream side openings of the jet holes 14a are distributed on double concentric circles C1 and C2 around a center CP of the orifice plate 14. In FIG. 10, the openings of four jet holes 14a are evenly spaced on the inner circle C1 while the openings of eight jet holes 14a are evenly spaced on the outer circle C2. Specifically, a total of twelve jet holes 14a are formed in the orifice plate 14. By thus arranging the upstream side openings of the jet holes 14a on a plurality of circles, a greater number of jet holes 14a can be efficiently positioned within a limited space.

Further, in this embodiment, the upstream side openings of the jet holes 14a are arranged such that the openings on the outer circle C2 are not in radial alignment with those openings on the inner circle C1. In FIG. 10, each of the openings on the inner circle C1 is positioned between the openings on the outer circle C2. By thus arranging the upstream side openings of the jet holes 14a on a plurality of circles and in radial disalignment between the openings on the inner and outer circles C1 and C2, the jet holes 14a can be more efficiently positioned within a limited space. Further, in this case, greater spacing between the openings of the jet holes 14a is ensured, which greater spacing prevents the fuel energy flowing into each jet hole 14a from leaking to the adjacent jet holes 14a. With such arrangement, fuel flows into each jet hole 14a more smoothly and a decrease in jet velocity of fuel particles can be prevented, so that the fuel particles can be further atomized.

Further, with such a distribution of the upstream side openings of the jet holes 14a, interference between atomized fuel particles exhausted from the jet holes 14a can be prevented. If such interference occurs, the atomized fuel particles will coalesce into larger particles. Various studies were conducted to determine the relationship between the distance between the upstream side openings of the jet holes 14a and the particle size of the atomized fuel. As a result, it was determined that the particle size of the atomized fuel can be made smaller by setting the shortest distance L between the upstream side openings of the jet holes 14a (which distance therebetween is shown by reference numerals L1, L2 in FIG. 10) to satisfy the condition:

L>φd,

wherein φd is the diameter of the jet holes 14a. Accordingly, in this representative embodiment, the shortest distance L between the upstream side openings of the jet holes 14a is set to be greater than the diameter φd of the jet holes 14a.

If the inclined axes S of the jet holes 14a are arranged to interfere with each other, the atomized fuel exhausted from the jet holes 14a will interfere with each other and coalesce into larger particles. Therefore, by arranging the inclined axes S of the jet holes 14a so as not to interfere with each other, the atomized fuel can be prevented from coalescing into larger particles. Accordingly, in this embodiment, the jet holes 14b are formed along the inclined axes S that do not interfere with each other.

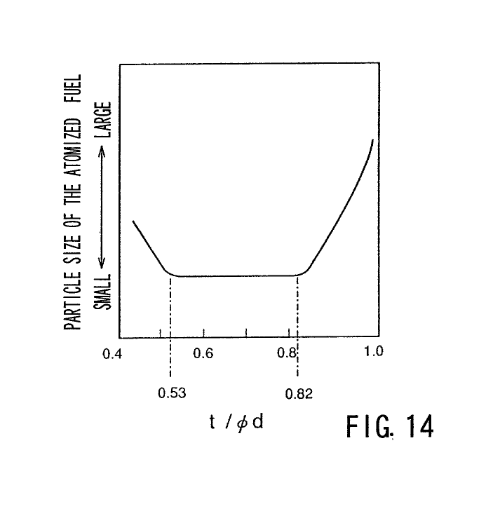

As a result of various studies, it was also determined that the ratio (t/φd) of the thickness t of the orifice plate 14 to the diameter φd (see FIG. 11) of the jet holes 14 affects the particle size of the atomized fuel. Specifically, the particle size of atomized fuel exhausted from the jet holes 14 was measured with respect to a variety of orifice plates 14 having different ratios (t/φd) of the thickness t of the orifice plate 14 to the diameter φd of the jet holes 14. The results are shown in FIG. 14, in which the abscissa represents the ratio (t/φd) and the ordinate represents the particle size of the atomized fuel. As is clear from FIG. 14, the particle sizes are smallest when the ratio (t/φd) is in the range from about 0.53 to 0.82.

Therefore, the particle size of the atomized fuel can be made smaller by setting the ratio (t/φd) of the thickness t of the orifice plate 14 to the diameter φd of the jet holes 14, to satisfy the condition:

0.53≦t/φd≦0.82.

The thickness t of the orifice plate 14 and the diameter φd of the jet holes 14 must be set within a range in which press molding of the orifice plate 14 is feasible.

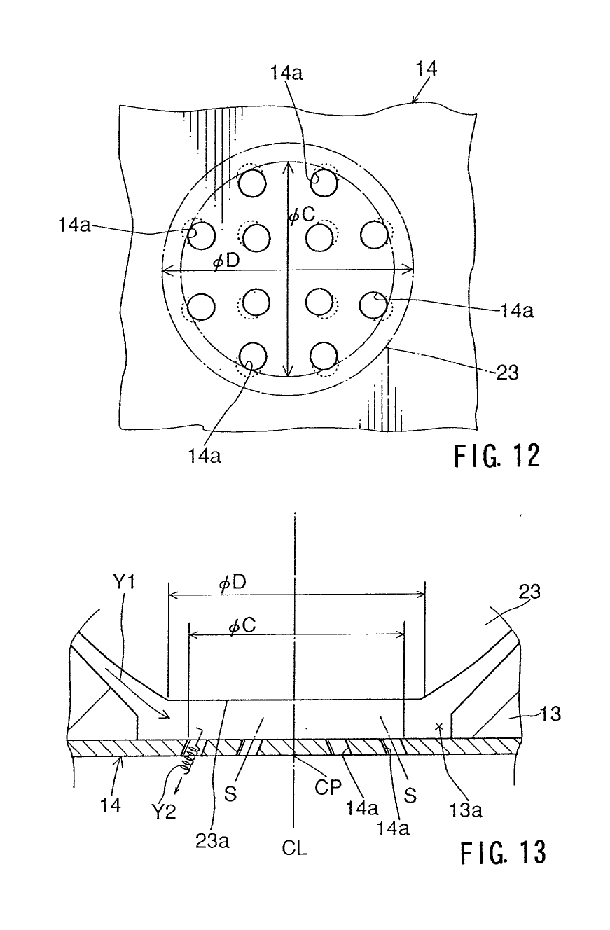

FIG. 12 is a partial end view of the orifice plate 14 seen from the upstream side thereof and FIG. 13 is a sectional view of the front end of the movable element 20 and surrounding parts. As shown in FIG. 13, the surface 23a 2 0 of the ball valve 23 (see FIGS. 6 to 8) that faces the orifice plate 14 is flat in this representative embodiment. In FIGS. 12 and 13, φD is the diameter of the flat surface 23a, and φC is the diameter of a circle circumscribed around the upstream side openings of the jet holes 14a that are farthest from the central point CP on the center line CL of the flat surface 23a.

In this representative embodiment, the diameter φD of the flat surface 23a and the diameter φC of the circumscribed circle are set to be:

φD>φC.

Specifically, the upstream side openings of the jet holes 14a are located within the circle of the diameter φD in the orifice plate 14 that faces the flat surface 23a.

With such a design, fuel passes between the valve seat 13 and the ball valve 23 of the movable element 20 and flows toward the center of the orifice plate 14. Thus, the fuel flows in a smooth stream without energy loss until just before entering the jet holes 14a (shown by arrow Y1 in FIG. 13). Then, because the jet holes 114a are inclined with respect to the central axis of the orifice plate 114 such that they are directed downward and away from the central axis of the orifice plate, the direction of the stream of fuel is changed suddenly upon entering the jet holes 14a. As a result, turbulent flow (shown by arrow Y2 in FIG. 13) is produced within the jet holes 14a. Thus, with such an arrangement of the jet holes 14a, turbulent flow can be produced within the jet holes 14a, while avoiding a decrease in jet velocity of fuel particles that is exhausted from the jet holes 14a. As a result, the injected fuel particles can be further atomized.

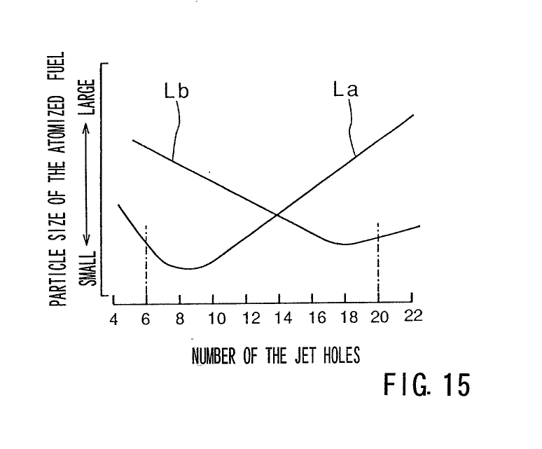

The number of the jet holes 14a to be formed in the orifice plate 14 can be determined by measuring the particle size of the atomized fuel exhausted from the jet holes 14a with respect to a variety of orifice plates 14 having different numbers of the jet holes 14a. Results are shown in FIG. 15 to show the relationship between the particle size of the atomized fuel and the number of the jet holes 14a. In this measurement, the ratio (t/φd) of the thickness t of the orifice plate 14 to the diameter φd of the jet holes 14a was set to 0.7. In FIG. 15, the abscissa represents the number of the jet holes 14a and the ordinate represents the particle size of the atomized fuel. Characteristic line La shows the result of measurements in which the fuel injection flow rate was set to a minimum, and characteristic line Lb shows the result of measurements in which the fuel injection flow rate was set to a maximum. As clearly seen from FIG. 15, when the number of the jet holes 14a is in the range of about eight to eighteen, the particle size of the atomized fuel is smaller than in the case of a lesser or greater number of the jet holes 14a.

As described above, by appropriately determining the number and the positional arrangement of the jet holes 14a to be formed in the orifice plate 14 and the ratio (t/φd) of the thickness t of the orifice plate 14 to the diameter φd of the jet holes 14a, the fuel particles can be further atomized.

Further, as shown in FIG. 10, by disposing the upstream side openings of the jet holes 14a on a plurality of circles C1 and C2, a greater number of the jet holes 14a can be efficiently positioned within a limited space. In addition, by disposing the upstream side openings of the jet holes 14a in a manner to avoid radial alignment and optimally by disposing the openings such that the shortest distance L between the upstream side openings of the jet holes 14a is greater than the diameter φd of the jet holes 14a, fuel flows into each jet hole 14a more smoothly and a decrease in jet velocity of fuel particles can be prevented. Thus, further atomization of the fuel particles can be achieved.

Moreover, by forming the jet holes 14b along the inclined axes S that do not interfere with each other, the atomized fuel exhausted from the jet holes 14a can be prevented from interfering with each other and hence from coalescing into larger particles.

Further, as shown in FIG. 13, a flat surface 23a having a diameter φD may be formed on the portion of the ball valve 23 that faces the orifice plate 14. The upstream side openings of the jet holes 14a can be located within the circle of the diameter φD in the orifice plate 14 that faces the flat surface 23a. Also, the jet holes 14a can be formed along the respective inclined axes S that are inclined with respect to the central axis of the orifice plate 14 such that they are directed downward and away from the central axis of the orifice plate. With such an arrangement, fuel flows in a smooth stream until just before entering the jet holes 14a and a decrease in jet velocity of fuel particles can be prevented. Upon entering the jet holes 14a, the direction of the stream of fuel is changed suddenly, which can produce turbulent flow within the jet holes 14a. Thus, the atomization of the fuel particles can be further promoted.

(Second Embodiment)

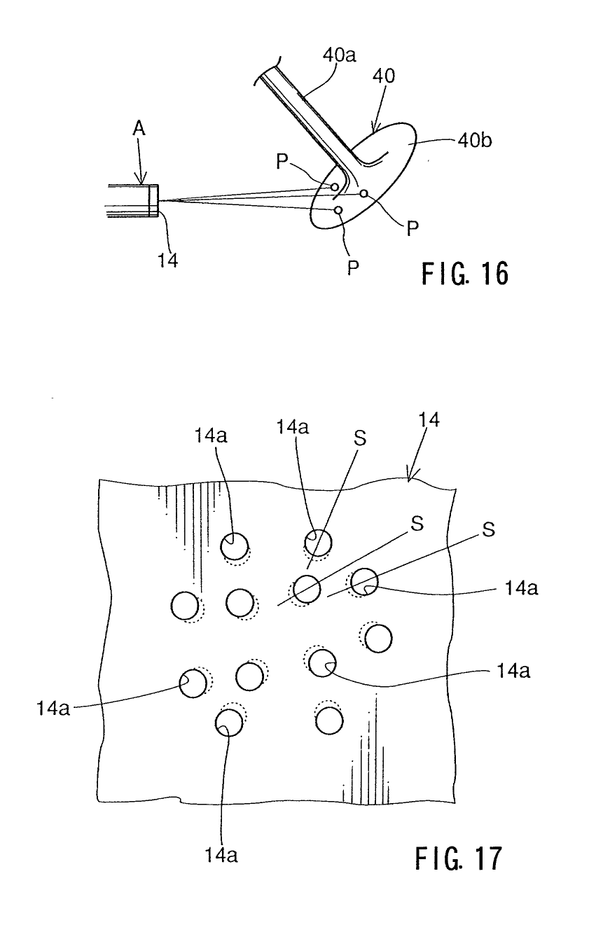

A second representative embodiment will now be described with reference to FIGS. 16 and 17. FIG. 16 is an explanatory view showing a target point for injected fuel. FIG. 17 is a partial end view of the orifice plate as seen from the downstream side. The second representative embodiment is a modification of the first representative embodiment, and only changed or modified portions will be discussed. Parts identical or substantially identical to those in the first embodiment are given like numerals as in the first embodiment

As shown in FIG. 16, the jet holes 14a of the second representative embodiment can be formed such that respective target points P for fuel exhausted from the jet holes hits a head portion 40b of an intake valve 40. Specifically, as shown in FIG. 17, the jet holes 14a can be formed along the respective axes S that extend onto the head portion 40b of the intake valve 40. Each of the axes S of the jet holes 14a can be defined such that the fuel exhausted from the jet holes does not interfere with a shaft 40a of the intake valve. With such an arrangement, excessive spread of atomized fuel exhausted from the jet holes 14a can be prevented which may otherwise be caused by its interference with the shaft 40a of the intake valve 40. As a result, deterioration of response that may be caused by a phenomenon in which liquid fuel accumulates on the air-fuel mixture port can be prevented. In addition, each of the axes S of the jet holes 14a is defined such that atomized fuel exhausted from the jet holes does not interfere on the downstream side. Thus, the atomized fuel is prevented from coalescing into larger particles. It will be noted that the inclination of the axes S is shown in exaggerated form in FIG. 17.

(Third Embodiment)

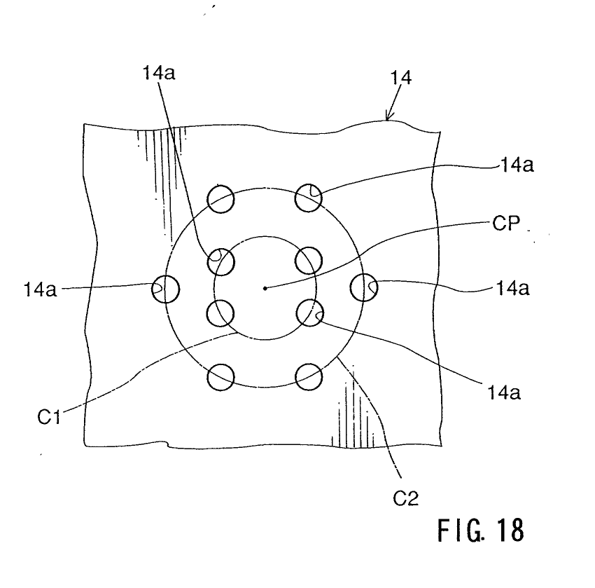

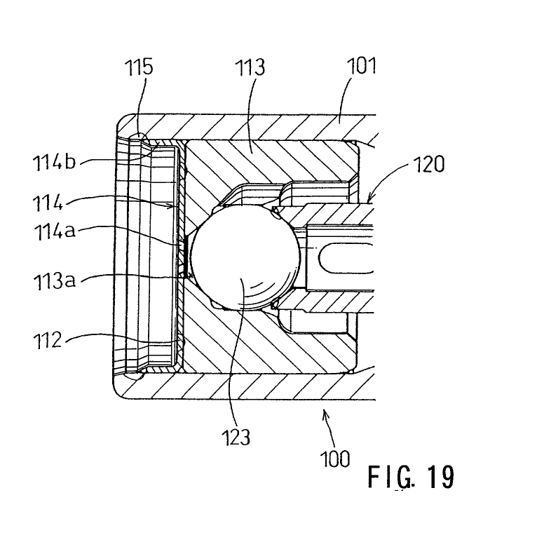

A third representative embodiment will now be described with reference to FIG. 18. FIG. 18 is a partial end view of the orifice plate as seen from the upstream side. Like the second representative embodiment, the third representative embodiment is also a modification of the first representative embodiment, and only changed or modified portions will be discussed. In the third representative embodiment, as shown in FIG. 18, the plurality of jet holes 14a are dispersed on the double concentric circles C1 and C2 around the center CP of the orifice plate 14. In this embodiment, the jet holes 14a on the outer circle C2 are evenly spaced while the jet holes 14a on the inner circle C1 are not evenly spaced with each other. Further, the jet holes 14a are arranged not to be in radial alignment with each other.

As noted above, the present invention is not limited to the constructions that have been described as the representative embodiments, but rather, may be added to, changed, replaced with alternatives or otherwise modified without departing from the spirit and scope of the invention. For example, a plurality of means for atomizing fuel have been described as being utilized in combination, but the individual means may be utilized separately. Further, the way of combination of the means may be changed to other various ways. The flat surface 23a of the movable element 20 is not limited to a plane surface, but it may be, for example, an obtuse conical end surface that is close to plane, that is, in the order of 178°. This invention is applicable as an injector for fluids other than fuel. In this case, the invention may be represented as a fluid injector.

1. A fuel injector comprising:
a fuel jet opening,
a movable element that can intermittently contact said jet opening to open and close the jet opening, and
an orifice plate disposed on the downstream side of said jet opening and having between about 8 to 18 jet holes, the thickness t of said orifice plate and the diameter φd of said jet holes satisfying a ratio of about 0.53≦t/φd≦0.82.

2. The fuel injector as set forth in claim 1, wherein:
said movable element has a flat surface of a diameter φD formed in a portion of the movable element that intermittently contacts said orifice plate; and
said jet holes are disposed within a circle of the diameter φD in the orifice plate that intermittently contacts said flat surface.

3. The fuel injector as set forth in claim 2, wherein:
said jet holes are formed along respective inclined axes that are inclined with respect to the central axis of the orifice plate such that the jet holes are directed downward and away from the central axis of the orifice plate.

4. The fuel injector as set forth in claim 3, wherein:
said inclined axes of the jet holes are defined so as not to interfere with each other.

5. The fuel injector as set forth in claim 3, wherein:
said jet holes are formed along respective axes that extend toward a head portion of an intake valve.

6. The fuel injector as set forth in claim 1, wherein:
upstream side openings of said jet holes are arranged on a single circle.

7. The fuel injector as set forth in claim 6, wherein:
upstream side openings of said jet holes are arranged on at least two circles.

8. The fuel injector as set forth in claim 6, wherein:
a shortest distance L between said upstream side openings of the jet holes is less than the diameter φd of the jet holes.

9. A fuel injector comprising:
a fuel jet opening,
a movable element that can intermittently contact said jet opening to open and close the jet opening, and
an orifice plate disposed on a downstream side of said jet opening and having a plurality of jet holes formed therein, wherein:
said movable element has a flat surface of diameter φD formed in a portion of the movable element that can intermittently contact said orifice plate, said jet holes are located within a circle of the diameter φD in the orifice plate that can intermittently contact said flat surface, said jet holes are formed along respective inclined axes that are inclined with respect to the central axis of the orifice plate such that the jet holes are directed downward and away from the central axis of the orifice plate; and said inclined axes of the jet holes are defined so as not to interfere with each other.

10. A fuel injector comprising:
an orifice plate disposed on a downstream side of a fuel jet opening and having between about 8 to 18 jet holes, the thickness t of said orifice plate and the diameter φd of said jet holes satisfying a ratio of about 0.53≦t/φd≦0.82.
